(19) United States
(12) Patent Application Publication
(10) Pub. No.: US 2014/0344638 A1
(43) Pub. Date: Nov. 20, 2014

(54) SIGNAL PROCESSING DEVICE, SIGNAL PROCESSING METHOD, AND COMMUNICATION DEVICE

(71) Applicant: FUJITSU LIMITED, Kawasaki-shi (JP)

(72) Inventors: Kiyoshi TAGUCHI, Kawasaki (JP); Hirotoshi SHIMIZU, Yokohama (JP); Shunji MIYAZAKI, Kawasaki (JP); Noboru KOBAYASHI, Tokorozawa (JP)

(73) Assignee: FUJITSU LIMITED, Kawasaki-shi (JP)

(21) Appl. No.: 14/279,071

(22) Filed: May 15, 2014

(30) Foreign Application Priority Data
May 17, 2013 (JP) 2013-105614

(51) Int. Cl. G06F 11/10; H04L 1/08

(52) U.S. Cl. CPC G06F 11/10; H04L 1/08
USPC 714/748

(57) ABSTRACT

A signal processing device including: a first memory, and a processing circuit coupled to the first memory and configured to perform decoding of a first received signal based on first likelihood data of the first received signal, transfer the first likelihood data to a second memory that is external to the signal processing device, only when the decoding is unsuccessful, and combine the first likelihood data loaded from the second memory with second likelihood data of a second received signal that corresponds to retransmitted signal of the first received signal.

### CROSS-REFERENCE TO RELATED APPLICATION

This application is based upon and claims the benefit of priority from the prior Japanese Patent Application No. 2013-105614 filed on May 17, 2013, the entire contents of which are incorporated herein by reference.

### FIELD

The embodiments discussed herein are related to a signal processing device, a signal processing method, and a communication device.

### BACKGROUND

In the related art, hybrid automatic repeat request (HARQ) obtained by combining ARQ with forward error correction (FEC) is known.

Retransmission of HARQ is performed, for example, in units of transport blocks. For example, such a technology is known that only a code block to be transmitted is selected from a plurality of code blocks obtained by dividing a transport block, and transmission of a transport block that includes only selected code blocks is performed (for example, see Japanese Laid-open Patent Publication No. 2010-147755).

On the HARQ receiving side, a received data is stored in an incremental redundancy (IR) buffer, and an error is corrected by combining the received data with initial transmission data. The capacity of the IR buffer is defined, for example, in 3rd Generation Partnership Project (3GPP).

### SUMMARY

According to an aspect of the invention, a signal processing device includes a first memory, and a processing circuit coupled to the first memory and configured to perform decoding of a first received signal based on first likelihood data of the first received signal, transfer the first likelihood data to a second memory that is external to the signal processing device, only when the decoding is unsuccessful, and combine the first likelihood data loaded from the second memory with second likelihood data of a second received signal that corresponds to retransmitted signal of the first received signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating an example of a signal processing device according to a first embodiment;

FIG. 1B is a diagram illustrating an example of a flow of a signal in the signal processing device illustrated in FIG. 1A;

FIG. 2 is a diagram illustrating an example of a mobile terminal according to a second embodiment;

FIG. 3 is a diagram illustrating an example of a baseband processor;

FIG. 4 is a diagram illustrating an example of a structure of a decoder that supports LTE;

FIG. 5 is a diagram illustrating an example of a structure of a decoder that supports HSDPA;

FIG. 6 is a diagram illustrating an example of a communication system;

FIG. 7A is a diagram (part 1) illustrating a first example of processing timing of each unit in the decoder;

FIG. 7B is a diagram (part 2) illustrating the first example of the processing timing of each of the units in the decoder;

FIG. 7C is a diagram (part 3) illustrating the first example of the processing timing of each of the units in the decoder;

FIG. 8A is a diagram (part 1) illustrating a second example of processing timing of each of the units in the decoder;

FIG. 8B is a diagram (part 2) illustrating the second example of the processing timing of each of the units in the decoder;

FIG. 8C is a diagram (part 3) illustrating the second example of the processing timing of each of the units in the decoder;

FIG. 9A is a diagram (part 1) illustrating a third example of processing timing of each of the units in the decoder;

FIG. 9B is a diagram (part 2) illustrating the third example of the processing timing of each of the units in the decoder;

FIG. 9C is a diagram (part 3) illustrating the third example of the processing timing of each of the units in the decoder;

FIG. 10A is a diagram (part 1) illustrating a fourth example of processing timing of each of the units in the decoder;

FIG. 10B is a diagram (part 2) illustrating the fourth example of the processing timing of each of the units in the decoder; and

FIG. 10C is a diagram (part 3) illustrating the fourth example of the processing timing of each of the units in the decoder.

### DESCRIPTION OF EMBODIMENTS

In the above-described technology in the related art, however, the IR buffer is provided in an integrated circuit that performs decoding by the HARQ, so that there is a problem that it is difficult to increase the capacity of the IR buffer and to cope with an increase in data rate. It is conceivable that an IR buffer is provided in an external memory of the integrated circuit that performs decoding by the HARQ, but there is a problem that power consumption used for access the IR buffer is increased.

According to embodiments, a signal processing device, a control method, and a communication device that may suppress the power consumption are provided.

A signal processing device, a control method, and a communication device according to the embodiments are described in detail below with reference to the drawings.

### First Embodiment

### Signal Processing Device According to a First Embodiment

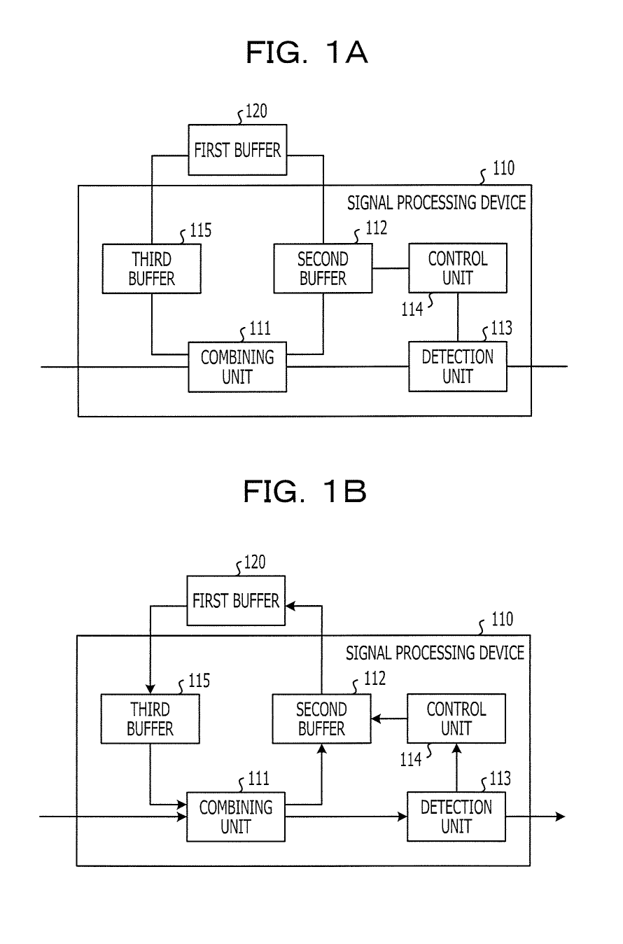

FIG. 1A is a diagram illustrating an example of a signal processing device according to a first embodiment. FIG. 1B is a diagram illustrating an example of a flow of a signal in the signal processing device illustrated in FIG. 1A. As illustrated in FIGS. 1A and 1B, a signal processing device 110 according to the first embodiment includes a combining unit 111, a second buffer 112, a detection unit 113, and a control unit 114. In addition, the signal processing device 110 may further include a third buffer 115. The signal processing device 110 executes decoding processing using likelihood data that is obtained by demodulation processing for a received signal.

A first buffer 120 is, for example, a memory that is provided outside of an integrated circuit (for example, the signal processing device 110) that includes the combining unit 111. As a result, an increase in the capacity of the first buffer is facilitated as compared with a structure in which the first buffer 120 is included in the integrated circuit that includes the combining unit 111. The first buffer 120 is, for example, an IR buffer that temporarily stores soft decision data of a received code string in order to perform combining based on HARQ.

Received data is input to the combining unit 111. The received data is, for example, data that is received by a reception device that includes the signal processing device 110. When the input data is initial transmission data, the combining unit 111 outputs the input data to the second buffer 112 and the detection unit 113.

In addition, when the input data is retransmission data, the combining unit 111 combines (performs HARQ combining on) the input data and data that corresponds to the input data (retransmission data), and that has been previously received and has been stored in the first buffer 120. The combining unit 111 outputs the combined data to the second buffer 112 and the detection unit 113.

Initial transmission data is, for example, data that is transmitted for the first time with respect to certain data. Retransmission data is, for example, data that is transmitted for a second or more time with respect to certain data, and is transmitted from the transmission side in response to a request from the reception side when an error is detected in the received data. The retransmission data may be data that is not completely the same as the initial transmission data, and for example, may be data that corresponds to a part of the initial transmission data. In addition, when the retransmission data is transmitted multiple times, pieces of retransmission data may be different from each other, and for example, may correspond to different portions of the initial transmission data.

The second buffer 112 is, for example, a memory that is included in the integrated circuit (for example, the signal processing device 110) that includes the combining unit 111. The second buffer 112 stores data received from the combining unit 111.

The detection unit 113 performs error detection on the data received from the combining unit 111. For example, the detection unit 113 performs error detection on the decoding result of the data received from the combining unit 111. For the error detection by the detection unit 113, for example, various error detection methods such as cyclic redundancy check (CRC) may be used. The detection unit 113 outputs the data received from the combining unit 111 and the result of the error detection. For data in which the detection unit 113 detects the error, ARQ is executed to the transmission side.

When an error is detected by the detection unit 113 in data that is stored in the second buffer 112, the control unit 114 transfers the data stored in the second buffer 112 to the first buffer 120, based on the result of the error detection which is received from the detection unit 113. In addition, when the detection unit 113 has not detected an error in the data that is stored in the second buffer 112, the control unit 114 discards the data that is stored in the second buffer 112 without transfer of the data to the first buffer 120.

As described above, in the signal processing device 110, when the first buffer 120 is provided externally, an increase in the capacity is facilitated. In addition, the data received from the combining unit 111 is temporarily stored in the second buffer 112, and only data in which an error is detected is transferred to the first buffer 120, so that an access to the first buffer 120 that is provided externally may be reduced. As a result, an increase in the capacity of the first buffer 120 is achieved, and the access to the first buffer 120 is reduced to suppress the power consumption.

In addition, the data output from the combining unit 111 may be transferred to the first buffer 120 through the internally-provided second buffer 112. As a result, destabilization of latency for writing onto the first buffer 120 due to the fact that the first buffer 120 is provided externally is reduced by the second buffer 112, and the operation of the signal processing device 110 may be stabilized.

In addition, the third buffer 115 is, for example, a memory that is internally-provided in the integrated circuit (for example, the signal processing device 110) that includes the combining unit 111. The third buffer 115 stores data that corresponds to retransmission data that is read from the first buffer 120 and input to the combining unit 111. When the third buffer 115 is provided in the signal processing device 110, the combining unit 111 reads the data that is stored in the third buffer 115 and combines the read data with the retransmission data.

As described above, the data that is read from the first buffer 120 may be transferred to the combining unit 111 through the internally-provided third buffer 115. As a result, destabilization of latency for reading from the first buffer 120 due to the fact that the first buffer 120 is provided externally is reduced by the third buffer 115, and the operation of the signal processing device 110 may be stabilized.

The signal processing device 110 may be applied, for example, to a reception device conforming to various communication standards such as Long Term Evolution (LTE), LTE-A, High Speed Downlink Packet Access (HSDPA).

### Second Embodiment

### Mobile Terminal According to a Second Embodiment

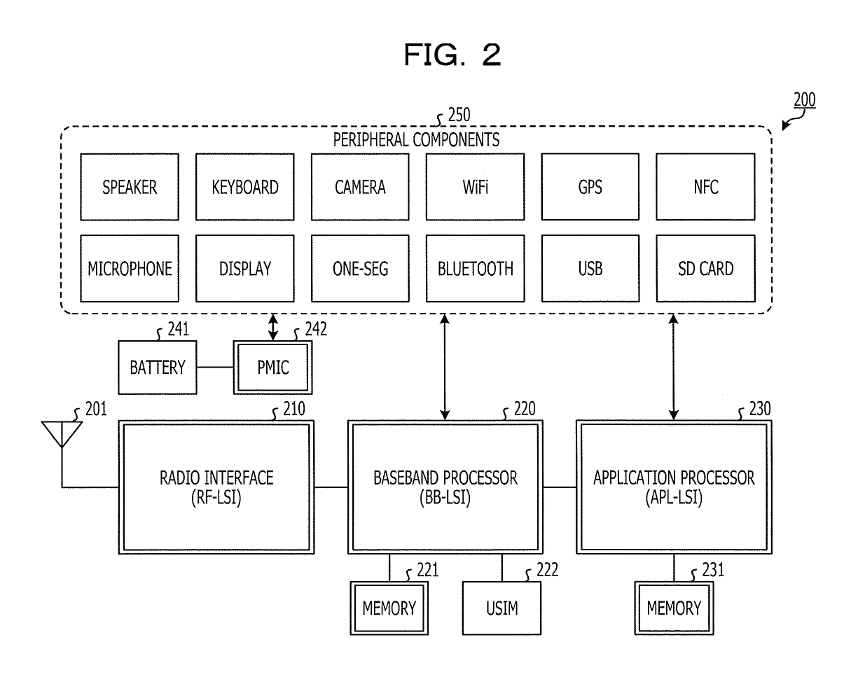

FIG. 2 is a diagram illustrating an example of a mobile terminal according to a second embodiment. A mobile terminal 200 illustrated in FIG. 2 includes an antenna 201, a radio interface 210, a baseband processor 220, a memory 221, a universal subscriber identity module (USIM) 222, an application processor 230, and a memory 231. In addition, the mobile terminal 200 further includes a battery 241, a power management integrated circuit (PMIC) 242, and peripheral components 250. The mobile terminal 200 is, for example, a communication device that includes the signal processing device 110 illustrated in FIGS. 1A and 1B in the baseband processor 220.

The antenna 201 performs transmission and reception of a radio signal. The radio interface 210 (RF-LSI) is an interface between an analog radio unit such as the antenna 201 and a digital processing unit such as the baseband processor 220.

The baseband processor 220 (baseband-large scale integration: BB-LSI) executes, for example, baseband processing of a call function and the like. The memory 221 is connected to the baseband processor 220 as a work memory. The memory 221 may be obtained, for example, by a synchronous dynamic random access memory (SDRAM), a flash read only memory (ROM), or the like. In addition, the USIM 222 that stores information to be used at the time of calling is connected to the baseband processor 220.

The application processor 230 (APL-LSI) executes an application to apply various functions to the mobile terminal 200. The memory 231 is connected as a work memory to the application processor 230. The memory 231 may be obtained, for example, by an SDRAM, a flash ROM, or the like. In addition, when the mobile terminal 200 is a mobile terminal that is connected to a personal computer or the like, the mobile terminal 200 may not include the application processor 230 and achieve a function of the application processor 230 by a central processing unit (CPU) or the like of the personal computer.

The battery 241 is, for example, a rechargeable battery such as a lithium ion battery. The PMIC 242 manages a power source of the mobile terminal 200. For example, the PMIC 242 supplies power obtained from the battery 241 to each of the units in the mobile terminal 200.

As an example of the peripheral components 250, there are a speaker, a microphone, a keyboard, a display, a camera, One-Seg, the Wireless Fidelity (Wi-Fi) (registered trademark), the Bluetooth (registered trademark), a Global Positioning System (GPS), a Universal Serial Bus (USB), near field communication (NFC), a Secure Digital (SD) card, and the like.

(Baseband Processor)

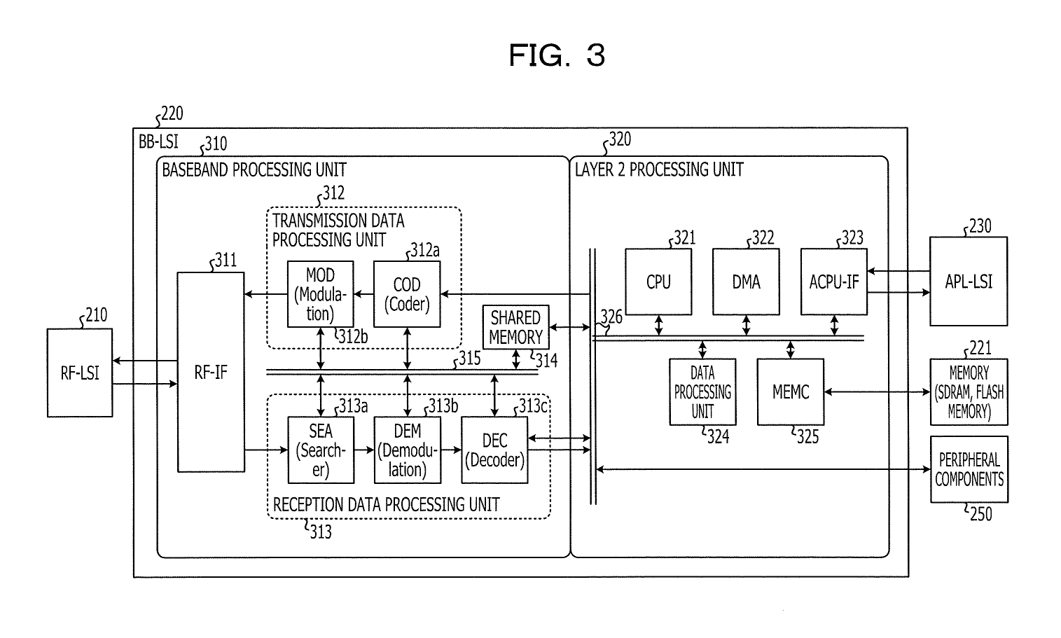

FIG. 3 is a diagram illustrating an example of the baseband processor. As illustrated in FIG. 3, the baseband processor 220 includes, for example, a baseband processing unit 310 and a layer 2 processing unit 320.

The baseband processing unit 310 includes a radio frequency interface (RF-IF) 311, a transmission data processing unit 312, a reception data processing unit 313, a shared memory 314, and a bus 315. The transmission data processing unit 312 includes a coder (COD) 312a and a modulator (MOD) 312b. The reception data processing unit 313 includes a searcher (SEA) 313a, a demodulator (DEM) 313b, and a decoder (DEC) 313c. The coder 312a, the modulator 312b, the searcher 313a, the demodulator 313b, the decoder 313c, and the shared memory 314 are connected to each other through the bus 315.

The RF-IF 311 is an interface between the baseband processor 220 and the radio interface 210 (for example, see FIG. 2). The coder 312a codes data (transmission data) that is received from the layer 2 processing unit 320. In addition, the coder 312a outputs the coded data to the modulator 312b.

The modulator 312b modulates the data that is received from the coder 312a. In addition, the modulator 312b outputs the modulated signal to the RF-IF 311. The signal that is output from the modulator 312b to the RF-IF 311 is input to the radio interface 210 through the RF-IF 311, and radio transmission of the signal is performed from the antenna 201 (for example, see FIG. 2).

The signal that is output from the radio interface 210 (received signal) is input to the searcher 313a through the RF-IF 311. The searcher 313a performs path search on the signal that is input through the RF-IF 311. In addition, the searcher 313a outputs the signal on which the path search is performed, to the demodulator 313b.

The demodulator 313b demodulates the signal that is output from the searcher 313a. In addition, the demodulator 313b outputs the demodulated data to the decoder 313c. The decoder 313c decodes the data that is received from the demodulator 313b. In addition, the decoder 313c outputs the decoded data to the layer 2 processing unit 320.

The shared memory 314 is a memory that is shared between the baseband processing unit 310 and the layer 2 processing unit 320. For example, input/output of data between the units in the baseband processing unit 310 and between the baseband processing unit 310 and the layer 2 processing unit 320 are performed through the shared memory 314. As the shared memory 314, for example, various RAMs such as a static random access memory (SRAM) may be used.

The layer 2 processing unit 320 includes a CPU 321, a direct memory access (DMA) 322, an ACPU-IF 323, a data processing unit 324, and a MEMC 325. The CPU 321, the DMA 322, the ACPU-IF 323, the data processing unit 324, and the MEMC 325 are connected to each other through a bus 326. In addition, the peripheral components 250 and the baseband processing unit 310 are connected to the bus 326.

The CPU 321 controls the whole layer 2 processing unit 320. The DMA 322 controls DMA transfer so as to perform communication between the memories such as the memory 221 and the shared memory 314 not through the CPU 321. The ACPU-IF 323 is an interface between the layer 2 processing unit 320 and the application processor 230.

The data processing unit 324 is, for example, a processor that executes data processing of the layer 2. The data processing unit 324 executes, for example, data processing of the layer 2 for data to be transmitted, and outputs the data for which the data processing is executed, to the transmission data processing unit 312. In addition, the data processing unit 324 executes the data processing of the layer 2 for the received data that is output from the reception data processing unit 313. The MEMC 325 is a memory controller that controls writing onto the memory 221 and reading from the memory 221.

The signal processing device 110 illustrated in FIGS. 1A and 1B may be applied, for example, to the decoder 313c. The first buffer 120 illustrated in FIGS. 1A and 1B may be applied, for example, to the memory 221. For example, the decoder 313c of the baseband processing unit 310 may be connected to the memory 221 through the bus 326 and the MEMC 325.

(Structure of the Decoder that Supports LTE)

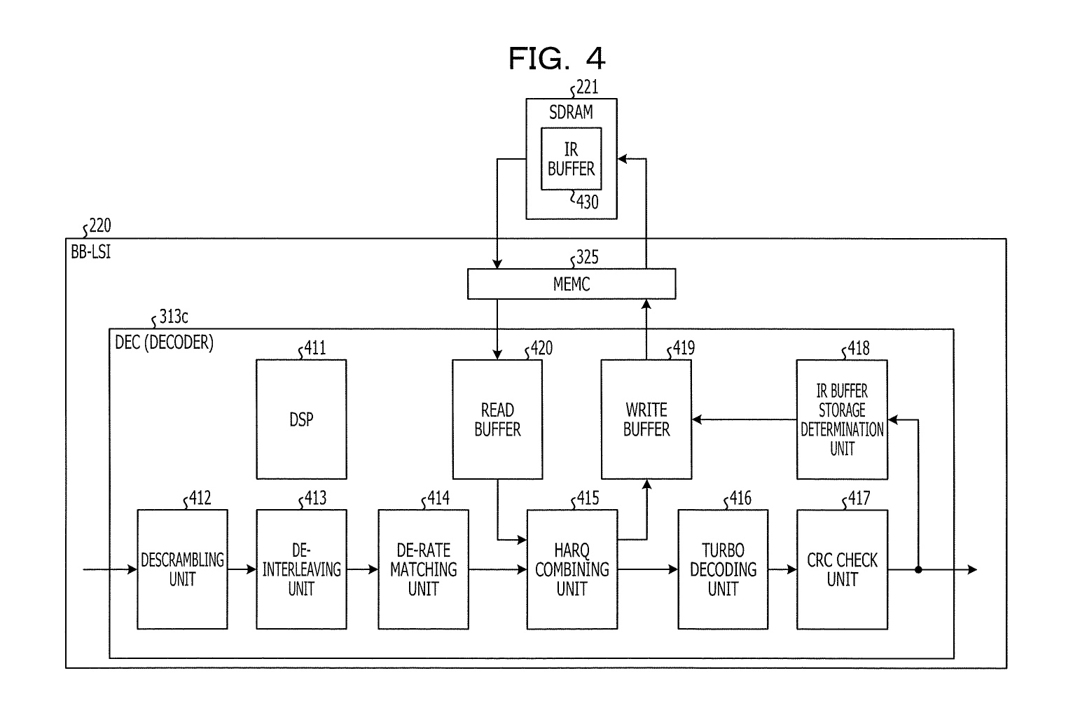

FIG. 4 is a diagram illustrating an example of a structure of the decoder that supports LTE. In the example of FIG. 4, the structure of the decoder 313c that supports LTE is described. As illustrated in FIG. 4, the decoder 313c includes a digital signal processor (DSP) 411, a descrambling unit 412, a de-interleaving unit 413, a de-rate matching unit 414, an HARQ combining unit 415, a turbo decoder 416, and a CRC check unit 417.

In addition, the decoder 313c includes an IR buffer storage determination unit 418, a write buffer 419, and a read buffer 420. In addition, in the memory 221, an IR buffer 430 that is used for HARQ combining by the HARQ combining unit 415 is provided. In the example illustrated in FIG. 4, the memory 221 is an SDRAM.

The DSP 411 controls processing timing and the like of each of the units in the decoder 313c. The descrambling unit 412 performs descrambling of the data that is output from the demodulator 313b (for example, see FIG. 3). In addition, the descrambling unit 412 outputs the descrambled data to the de-interleaving unit 413.

The de-interleaving unit 413 performs de-interleaving on the data that is output from the descrambling unit 412. In addition, the de-interleaving unit 413 outputs the data on which the de-interleaving has been performed, to the de-rate matching unit 414. The de-rate matching unit 414 performs de-rate matching on the data that is output from the de-interleaving unit 413. In addition, the de-rate matching unit 414 outputs the data on which the de-rate matching has been performed, to the HARQ combining unit 415.

When the data that is output from the de-rate matching unit 414 is initial transmission data, the HARQ combining unit 415 outputs the data that is output from the de-rate matching unit 414, to the turbo decoder 416 and the write buffer 419.

In addition, when the data that is output from the de-rate matching unit 414 is retransmission data, previously received data that corresponds to the retransmission data output from the de-rate matching unit 414 is read from the IR buffer 430 and stored in the read buffer 420. Such reading and storing are performed, for example, through control by the DSP 411. The HARQ combining unit 415 combines the data that is stored in the read buffer 420 and the retransmission data that is output from the de-rate matching unit 414, and outputs the combined data to the turbo decoder 416 and the write buffer 419.

As described above, when the data that is output from the de-rate matching unit 414 is initial transmission data, the HARQ combining unit 415 does not use data in the IR buffer 430. In addition, when the data that is output from the de-rate matching unit 414 is retransmission data, the HARQ combining unit 415 uses data in the IR buffer 430 in order to perform error correction. In addition, the HARQ combining unit 415 transfers the data that is obtained after the HARQ combining, to the write buffer 419, in order to use the data for error correction of the retransmission data.

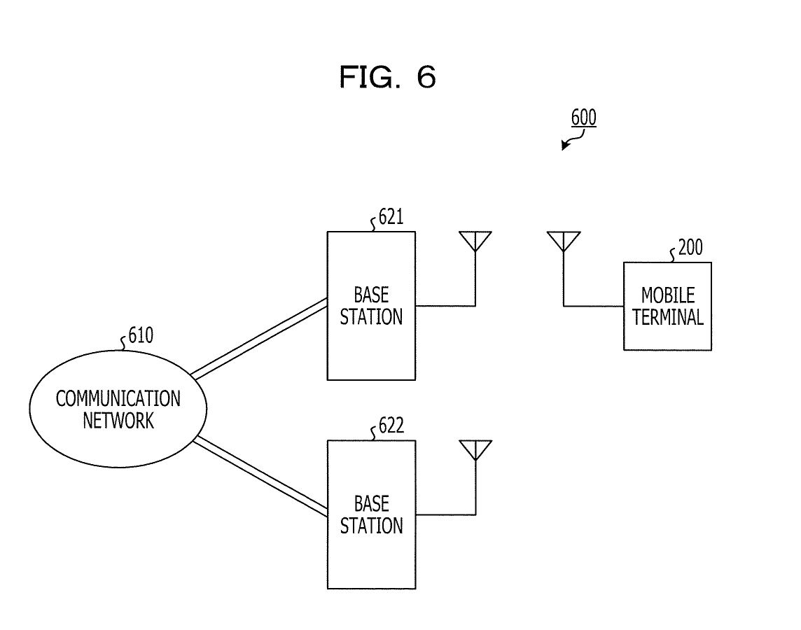

Initial transmission data is, for example, data that is transmitted for the first time. Retransmission data is, for example, data on which NG (presence of error) has been determined by CRC check is transmitted to the transmission side (for example, base stations 621 and 622 in FIG. 6) as NACK, and transmitted from the transmission side again. When the retransmission data is determined to be NG by the CRC check, the retransmission is further performed. However, a limit of the number of retransmissions may be set by a parameter of the communication system.

The turbo decoder 416 performs turbo decoding on the data that is output from the HARQ combining unit 415. In addition, the turbo decoder 416 outputs the data on which the turbo decoding has been performed, to the CRC check unit 417.

The CRC check unit 417 performs error detection by CRC check on the data that is output from the turbo decoder 416. The CRC check unit 417 outputs the data on which the CRC check is performed, with the result of the error detection. For example, the CRC check unit 417 performs at least one of CRC check in units of transport blocks and CRC check in units of code blocks.

The IR buffer storage determination unit 418 controls the write buffer 419, based on the result of the error detection, which is output from the CRC check unit 417. For example, when an error is detected in data that is stored in the write buffer 419, the IR buffer storage determination unit 418 performs control so that the data stored in the write buffer 419 is transferred to the IR buffer 430. In addition, when an error is not detected in the data that is stored in the write buffer 419, the IR buffer storage determination unit 418 discards the data that is stored in the write buffer 419 without transfer of the data to the IR buffer 430.

The write buffer 419 stores data that is output from the HARQ combining unit 415. In addition, the write buffer 419 discards the stored data or transfers the stored data to the IR buffer 430 by the control from the IR buffer storage determination unit 418. The data transfer from the write buffer 419 to the IR buffer 430 is performed, for example, through the MEMC 325 (for example, see FIG. 3).

For example, when retransmission data is input from the de-rate matching unit 414 to the HARQ combining unit 415 by the control of the DSP 411, the read buffer 420 reads the corresponding initial transmission data from the IR buffer 430 and stores the data. In addition, the read buffer 420 outputs the stored data to the HARQ combining unit 415.

When the data that is output from the HARQ combining unit 415 is stored in the write buffer 419, the data that is output from the HARQ combining unit 415 may be stored until the CRC check unit 417 performs the error detection. As a result, from among pieces of data that are output from the HARQ combining unit 415, only data in which the CRC check unit 417 detects an error may be transferred to the IR buffer 430.

In addition, when the IR buffer 430 is provided in the external memory 221 (SDRAM), an increase in the capacity of the IR buffer 430 is facilitated, but access latency for reading and writing of the IR buffer 430 is destabilized. To solve the problem, when the write buffer 419 is provided between the HARQ combining unit 415 and the IR buffer 430, access latency for writing of the IR buffer 430 may be reduced. In addition, when the read buffer 420 is provided between the HARQ combining unit 415 and the IR buffer 430, access latency for reading of the IR buffer 430 may be reduced.

As described above, in the baseband processing unit 310, the IR buffer 430 is provided in the external memory 221 to facilitate an increase in the capacity. For example, an increase in the capacity of the IR buffer 430 may be achieved while an increase in the size of the baseband processing unit 310 is avoided. In addition, an access to the IR buffer 430 that is provided in the external memory 221 may be reduced when the data output from the HARQ combining unit 415 is temporarily stored in the write buffer 419 and only data in which an error is detected is transferred to the IR buffer 430. As a result, an increase in the capacity of the IR buffer 430 is intended to cope with an increase in data rate and an access to the IR buffer 430 is reduced to suppress the power consumption.

In addition, retransmission is not performed on data in which an error is not detected, so that HARQ may be achieved for the data in which an error is not detected even when the data is discarded. As described above, when only the data in which an error is detected is transferred to the IR buffer 430, only the data on which retransmission is performed may be stored in the IR buffer 430. Generally, a percentage of error detected by CRC check is about 1%, so that access frequency to the IR buffer 430 may be reduced. In addition, amount of data that is stored in the IR buffer 430 may be reduced, thereby supporting further increase in the data rate.

The first buffer 120 illustrated in FIGS. 1A and 1B may be achieved, for example, by the IR buffer 430. The combining unit 111 illustrated in FIGS. 1A and 1B may be achieved, for example, by the HARQ combining unit 415. The second buffer 112 illustrated in FIGS. 1A and 1B may be achieved, for example, by the write buffer 419. The detection unit 113 illustrated in FIGS. 1A and 1B may be achieved, for example, by the CRC check unit 417. The control unit 114 illustrated in FIGS. 1A and 1B may be achieved, for example, by the IR buffer storage determination unit 418. The third buffer 115 illustrated in FIGS. 1A and 1B may be achieved, for example, by the read buffer 420.

(Structure of the Decoder that Supports HSDPA)

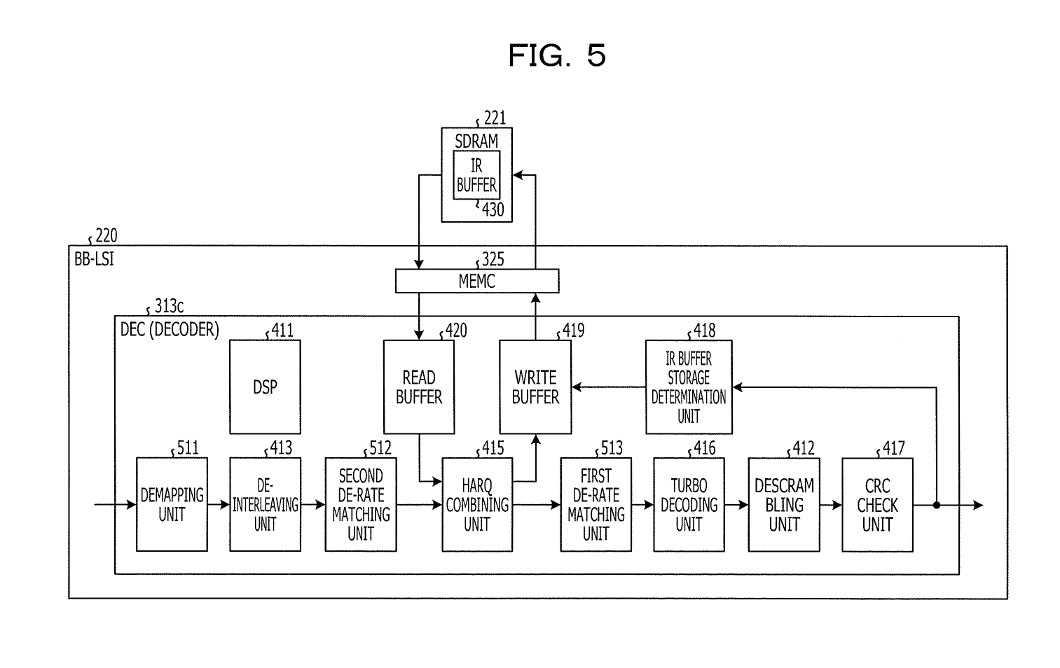

FIG. 5 is a diagram illustrating an example of a structure of the decoder that supports HSDPA. In FIG. 5, the same symbol is assigned to a portion that is similar to the portion illustrated in FIG. 4, and the description thereof is omitted. In the example illustrated in FIG. 5, a structure of the decoder 313c that supports HSDPA is described.

As illustrated in FIG. 5, the decoder 313c includes the DSP 411, a demapping unit 511, the de-interleaving unit 413, second and first de-rate matching units 512 and 513, the HARQ combining unit 415, the turbo decoder 416, and the descrambling unit 412. In addition, the decoder 313c includes the CRC check unit 417, the IR buffer storage determination unit 418, the write buffer 419, and the read buffer 420.

The demapping unit 511 performs demapping on the data that is output from the demodulator 313b (for example, see FIG. 3). In addition, the demapping unit 511 outputs the data on which the demapping has been performed, to the de-interleaving unit 413. The de-interleaving unit 413 performs de-interleaving on the data that is output from the demapping unit 511. In addition, the de-interleaving unit 413 outputs the data on which the de-interleaving has been performed, to the second de-rate matching unit 512.

The second de-rate matching unit 512 performs de-rate matching on the data that is output from the de-interleaving unit 413. In addition, the second de-rate matching unit 512 outputs the data on which the de-rate matching has been performed, to the HARQ combining unit 415.

When the data that is output from the second de-rate matching unit 512 is initial transmission data, the HARQ combining unit 415 outputs the data that is output from the second de-rate matching unit 512, to the first de-rate matching unit 513 and the write buffer 419. In addition, when the data that is output from the second de-rate matching unit 512 is retransmission data, the HARQ combining unit 415 combines the data that is stored in the read buffer 420 and the retransmission data that is output from the second de-rate matching unit 512. In addition, the HARQ combining unit 415 outputs the combined data, to the first de-rate matching unit 513 and the write buffer 419.

The first de-rate matching unit 513 performs de-rate matching on the data that is output from the HARQ combining unit 415. In addition, the first de-rate matching unit 513 outputs the data on which the de-rate matching has been performed, to the turbo decoder 416. The turbo decoder 416 performs turbo decoding on the data that is output from the first de-rate matching unit 513. In addition, the turbo decoder 416 outputs the data on which the turbo decoding has been performed, to the descrambling unit 412.

The descrambling unit 412 performs descrambling on the data that is output from the turbo decoder 416. In addition, the descrambling unit 412 outputs the data on which the descrambling has been performed, to the CRC check unit 417. The CRC check unit 417 performs error detection by CRC check on the data that is output from the turbo decoder 416. The CRC check unit 417 outputs the data on which the CRC check is performed, with the result of the error detection.

(Communication System)

FIG. 6 is a diagram illustrating an example of a communication system. As illustrated in FIG. 6, a communication system 600 includes the mobile terminal 200, a communication network 610, and the base stations 621 and 622. The mobile terminal 200 transmits and receives data to and from the communication network 610 by performing radio communication with at least one of the base stations 621 and 622 using HARQ.

At least one of the base stations 621 and 622 relays the transmission and reception of data between the mobile terminal 200 and the communication network 610 by performing wired communication with the communication network 610 and performing radio communication with the mobile terminal 200.

(Processing Timing of Each of the Units in the Decoder)

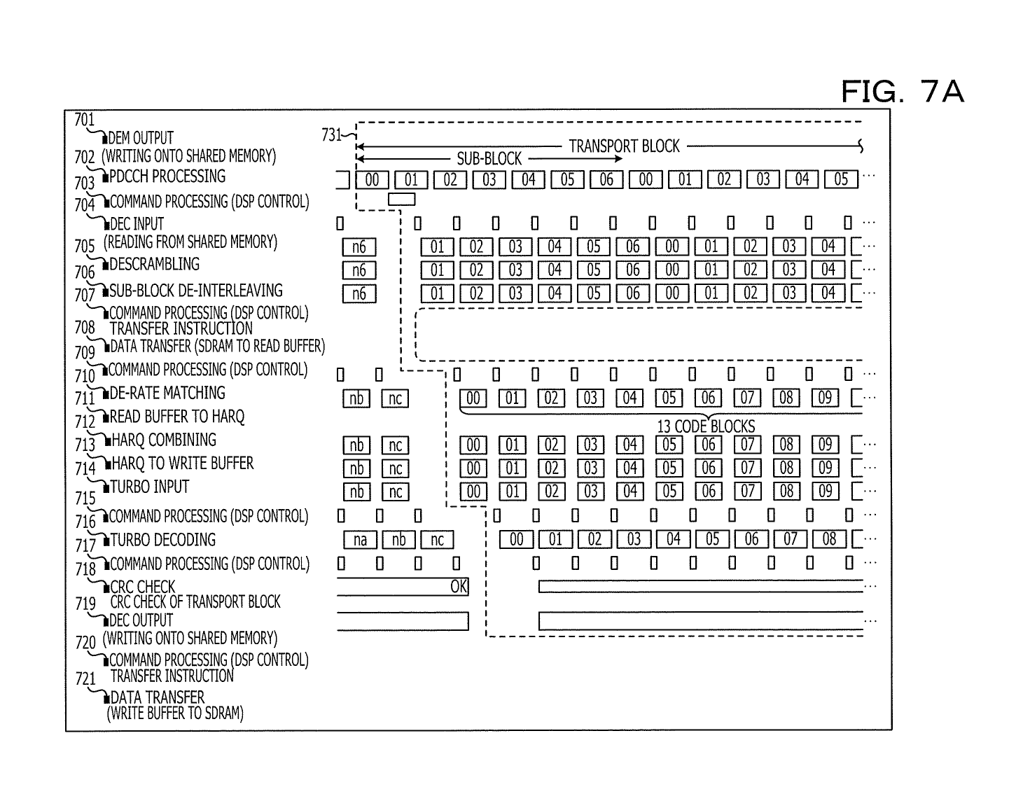

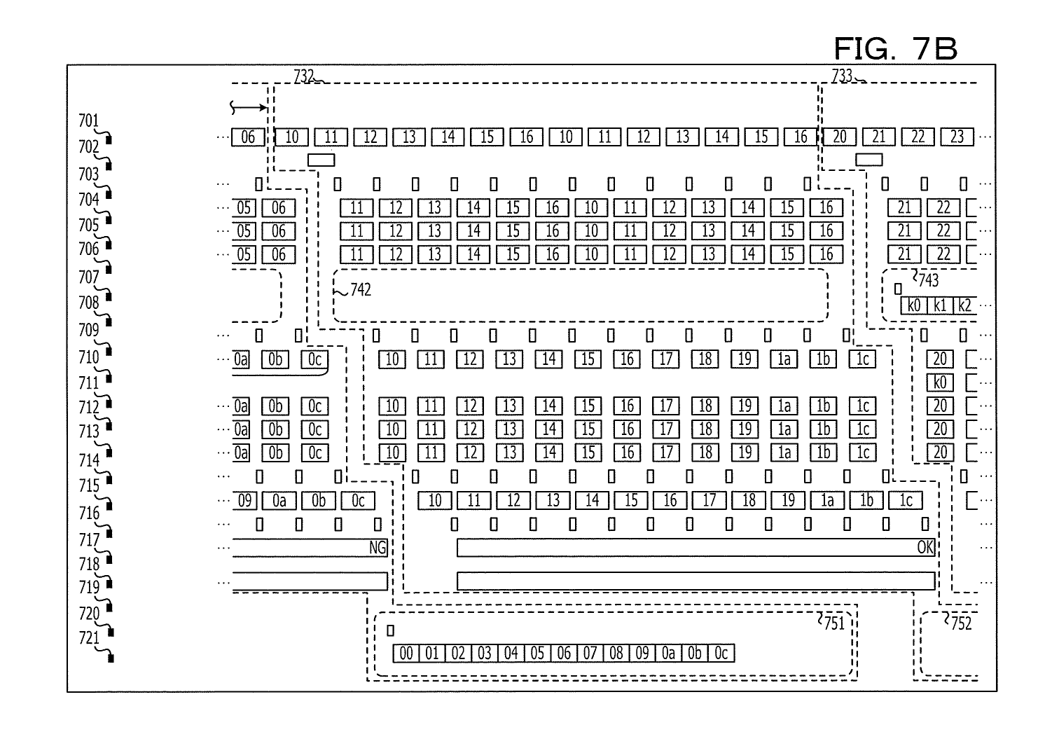

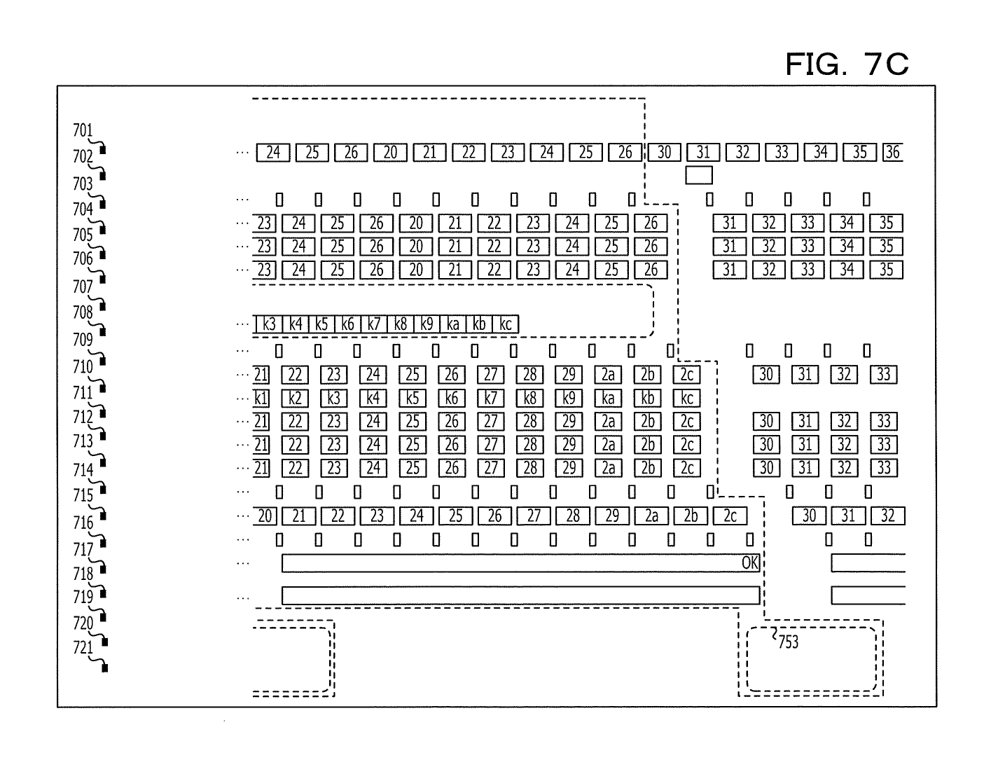

In FIGS. 7A to 10C, four control schemes based on differences of control of an access to the IR buffer 430 that is provided in the external memory 221 are described. In FIGS. 7A to 10C, processing of a physical downlink shared channel (PDSCH) of LTE is described as an example.

In LTE, a radio frame of 10 ms cycle is defined, and a frame that is obtained by dividing one radio frame into 10 is defined as a sub-frame. The cycle of the sub-frame is 1 ms. One transport block is included in a PDSCH inside one sub-frame, and 2 to 13 code blocks are included in one transport block. In FIGS. 7A to 10C, a case is described in which 13 code blocks are included in one transport block.

FIGS. 7A to 7C are diagrams illustrating a first example of processing timing of each of the units in the decoder. FIGS. 7A to 7C illustrate a case in which a timing chart of the processing of each of the units in the decoder 313c is divided into three. In FIGS. 7A to 7C, the horizontal direction indicates a time. The dotted line frame 731 indicates data and processing that are related to one transport block. The dotted line frames 732 and 733 indicate data and processing that are related to transport blocks that follow the transport block of the dotted line frame 731.

Data 701 (DEM output) indicates data that is output from the demodulator 313b. The data that is output from the demodulator 313b is written, for example, onto the shared memory 314 (writing onto the shared memory). Here, “00” to “06” in the data 701 constitute one sub-block, and two sub-blocks constitute one transport block. Here, “00” of the transport block is data that indicates the head of the transport block.

PDCCH processing 702 indicates physical downlink control channel (PDCCH) processing for the data 701 by the decoder 313c.

Command processing 703 is, for example, command processing from the DSP 411 for the shared memory 314, the descrambling unit 412, and the de-interleaving unit 413 (DSP control). Data 704 (DEC input) indicates data that is input to the decoder 313c. The data that is input to the decoder 313c is, for example, data that is read from the shared memory 314 (reading from the shared memory).

Data 705 (descrambling) indicates data on which descrambling is performed by the descrambling unit 412. Data 706 (sub-block de-interleaving) indicates data on which de-interleaving in units of sub-blocks is performed by the de-interleaving unit 413.

Command processing 707 is, for example, command processing from the DSP 411 for the MEMC 325 and the read buffer 420 (DSP control). In the command processing 707, data transfer is performed from the memory 221 to the read buffer 420. Data 708 (data transfer) indicates data that is transferred from the memory 221 to the read buffer 420.

The transport blocks that are enclosed by the dotted line frames 731 and 732 correspond to initial transmission, so that, as illustrated in symbols 741 and 742, data transfer from the memory 221 to the read buffer 420 is not performed. In addition, the transport block that is enclosed by the dotted line frame 733 corresponds to the initial transmission, so that as illustrated in a symbol 743, data transfer in the units of the code blocks from the memory 221 to the read buffer 420 is performed.

Command processing 709 is, for example, command processing from the DSP 411 for the de-rate matching unit 414, the HARQ combining unit 415, and the turbo decoder 416 (DSP control). Data 710 (de-rate matching) indicates data on which de-rate matching is performed by the de-rate matching unit 414.

Data 711 (read buffer to HARQ) indicates data that is transferred from the read buffer 420 to the HARQ combining unit 415. Data 712 (HARQ combining) indicates data that is output from the HARQ combining unit 415 (initial transmission data or combined data). Data 713 (HARQ to write buffer) indicates data that is transferred from the HARQ combining unit 415 to the write buffer 419. Data 714 (turbo input) is data that is input to the turbo decoder 416.

Command processing 715 is, for example, command processing from the DSP 411 for the turbo decoder 416 (DSP control). Data 716 (turbo decoding) is data that is decoded by the turbo decoder 416.

Command processing 717 is, for example, command processing from the DSP 411 for the CRC check unit 417 (DSP control). CRC check 718 indicates processing of CRC check of transport blocks (units) by the CRC check unit 417. Data 719 (DEC output) indicates data that is output from the decoder 313c (CRC check 718). The data that is output from the decoder 313c is, for example, written onto the shared memory 314 (writing onto the shared memory).

Command processing 720 (transfer instruction) is, for example, command processing from the DSP 411 for the IR buffer storage determination unit 418 (DSP control). Data 721 (data transfer) indicates data that is transferred from the write buffer 419 to the memory 221 (SDRAM) by control of the IR buffer storage determination unit 418.

In the examples illustrated in FIGS. 7A to 7C, CRC check of the transport block that is enclosed by the dotted line frame 731 is determined to be NG. Therefore, as illustrated in the symbol 751, the transport block that is enclosed by the dotted line frame 731 is transferred from the write buffer 419 to the memory 221 (SDRAM) in the unit of the code block.

In addition, CRC check of the transport blocks that are enclosed by the dotted line frames 732 and 733 is determined to be OK. Therefore, as illustrated in symbols 752 and 753, the transport blocks that that are enclosed by the dotted line frames 732 and 733 are discarded without transfer of the transport blocks from the write buffer 419 to the memory 221 (SDRAM).

In view of the maximum data rate, the write buffer 419 and the read buffer 420 may have a buffer capacity of 13 code blocks or more that is included in one transport block. In the examples illustrated in FIGS. 7A to 7C, the write buffer 419 has a buffer capacity of two transport blocks, but in a case in which a transfer capacity from the write buffer 419 to the memory 221 (SDRAM) or a processing capacity of the circuit is high, the write buffer 419 may have a buffer capacity of one transport block.

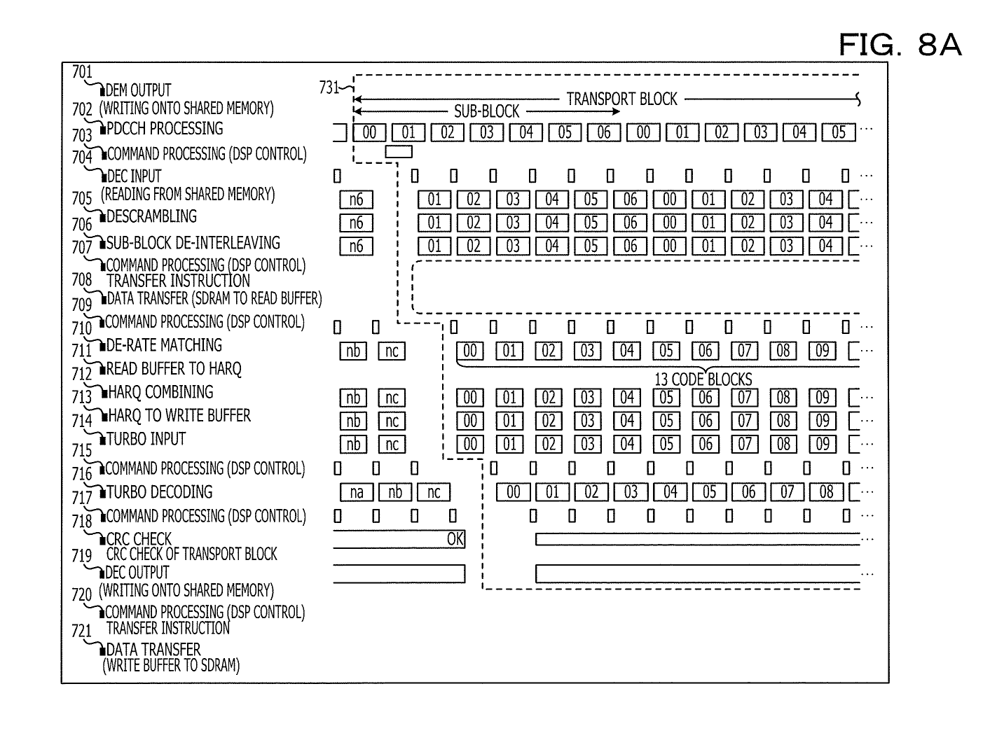

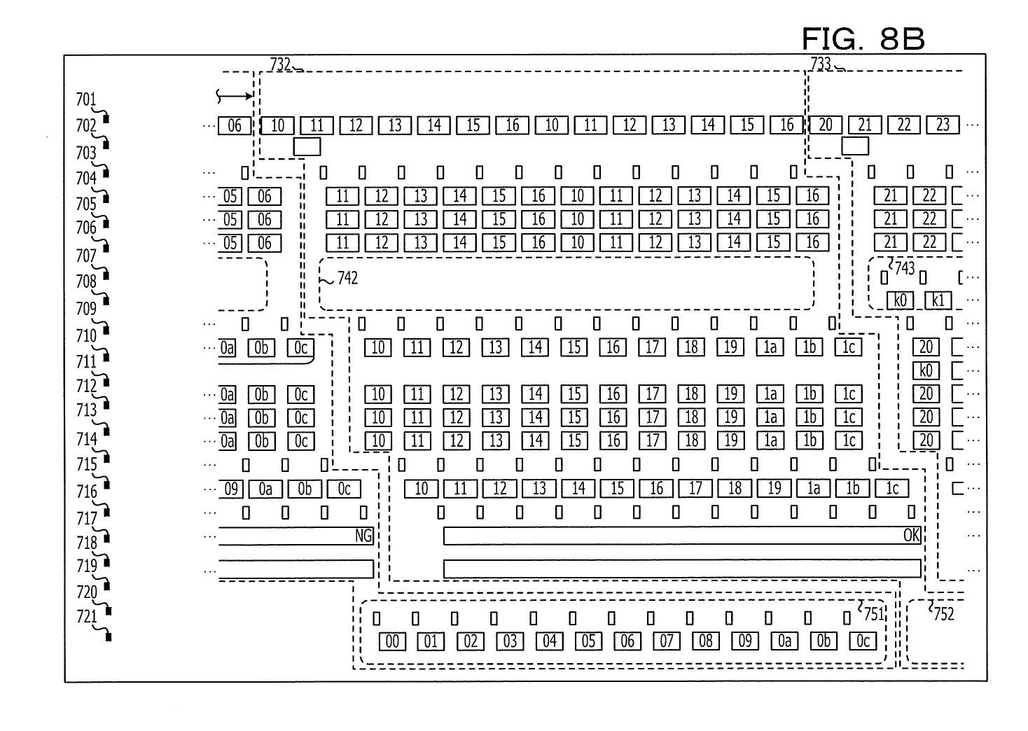

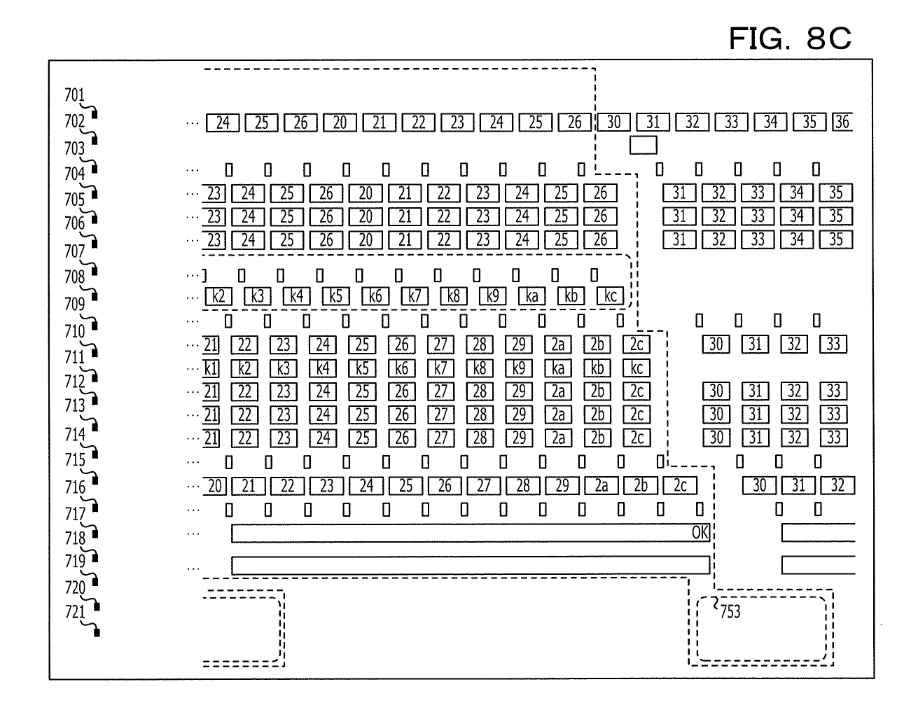

FIGS. 8A to 8C are diagrams illustrating a second example of processing timing of each of the units in the decoder. In FIGS. 8A to 8C, the same symbol is assigned to a portion that is similar to the portion that is illustrated FIGS. 7A to 7C, and the description thereof is omitted.

In the examples illustrated in FIGS. 8A to 8C, reading and writing from and onto the memory 221 (SDRAM) are distributed in the units of the code blocks in order to distribute load of an internal bus and reduce the capacity of the buffer. In this case, the read buffer 420 may have, for example, a buffer capacity of two code blocks. However, for processing delay of a block in another circuit format, the read buffer 420 may have a buffer capacity of three code blocks or more. In addition, in a case in which the transfer capacity from the memory 221 (SDRAM) to the read buffer 420 is high, the read buffer 420 may have a buffer capacity of one code block.

In addition, the write buffer 419 may have, for example, a buffer capacity of 14 code blocks. However, when the transfer capacity from the write buffer 419 to the memory 221 (SDRAM) or the processing capacity of the circuit is high, the write buffer 419 may have a buffer capacity of one code block to 13 code blocks. In addition, when the transfer capacity of the bus or the processing capacity of the circuit is low, the write buffer 419 may have a buffer capacity of 15 code blocks or more.

As described above, when the data stored in the write buffer 419 is transferred to the memory 221 in the unit of the code block (second block) that is smaller the unit of the transport block (first block), load distribution of the internal bus may be achieved.

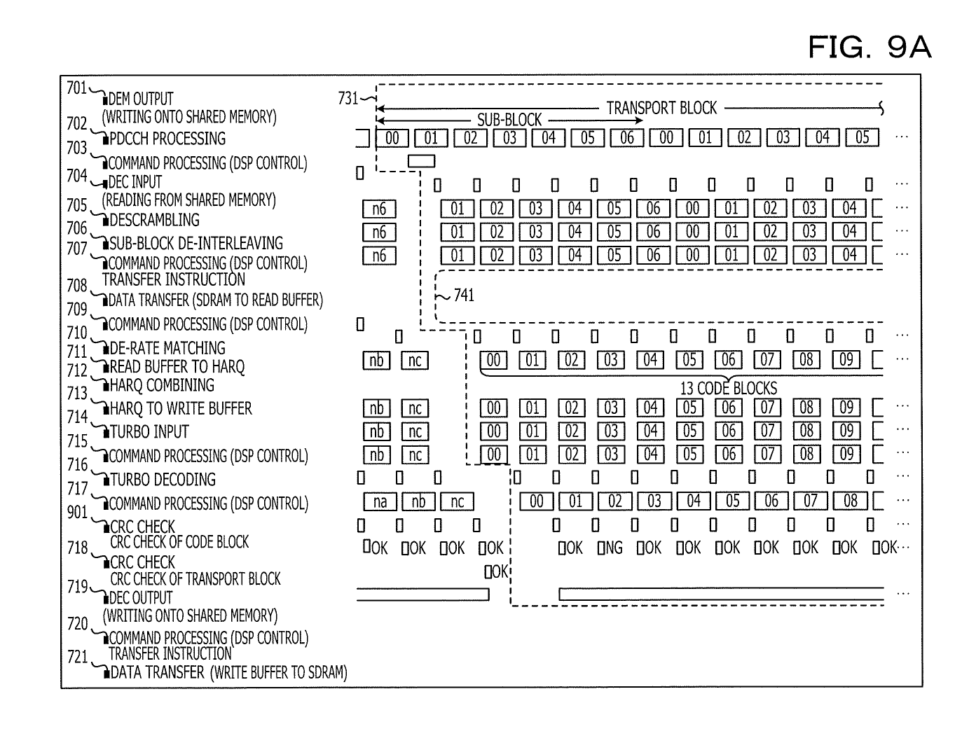

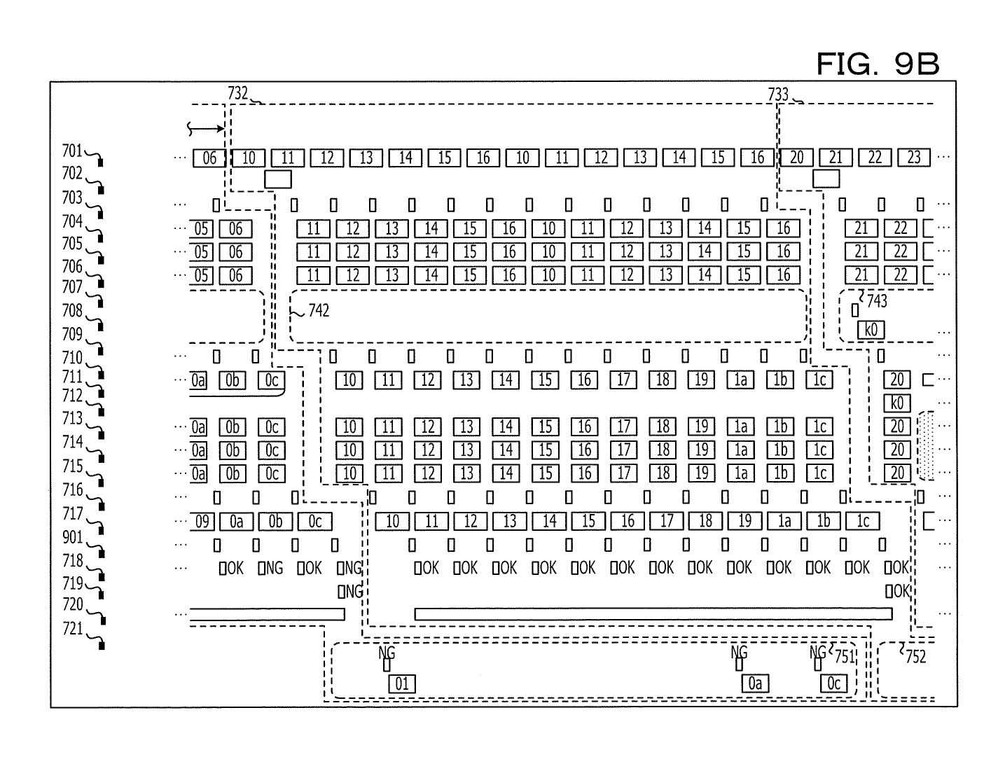

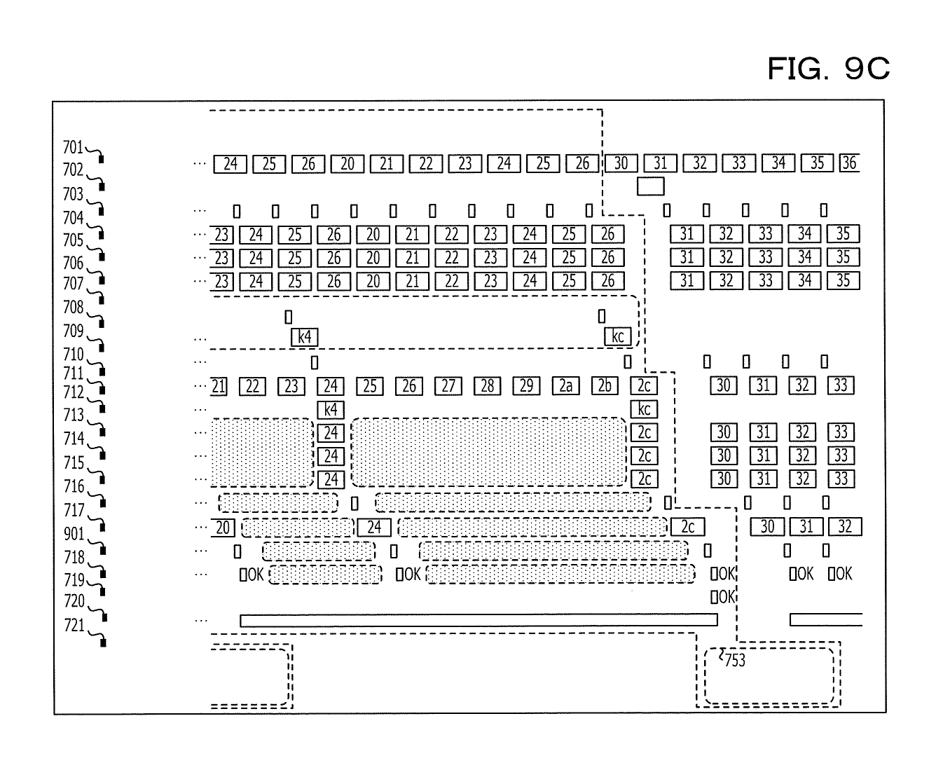

FIGS. 9A to 9C are diagrams illustrating a third example of processing timing of each of the units in the decoder. In FIGS. 9A to 9C, the same symbol is assigned to a portion that is similar to the portion illustrated in FIGS. 7A to 7C, and the description thereof is omitted. CRC check 901 illustrated in FIGS. 9A to 9C indicates processing of CRC check in the unit of the code block by the CRC check unit 417.

In the examples illustrated in FIGS. 9A to 9C, when CRC check in the unit of the transport block is determined to be NG, data of the code block in which CRC check in the unit of the code block is determined to be NG is transferred to the memory 221 (SDRAM). In addition, data of another code block is not transferred to the memory 221 (SDRAM).

The number of code blocks that are transfer targets to the memory 221 (SDRAM), which are included in one transport block corresponds to 1 to 13 blocks, but only the code block in which CRC check is determined to be NG is transferred to the memory 221 (SDRAM). As a result, for example, access frequency to the memory 221 (SDRAM) may be reduced as compared with the examples illustrated in FIGS. 8A to 8C. The buffer capacity of the write buffer 419 is similar to the examples illustrated in FIGS. 8A to 8C.

As described above, only data in the unit of the code block in which an error is detected, from among the pieces of data that are stored in the write buffer 419, may be transferred to the memory 221 using the error detection result in the unit of the code block (second block). As a result, an access to the memory 221 is reduced to suppress the power consumption. In addition, an amount of data that is stored in the memory 221 is reduced, thereby supporting further increase in the data rate.

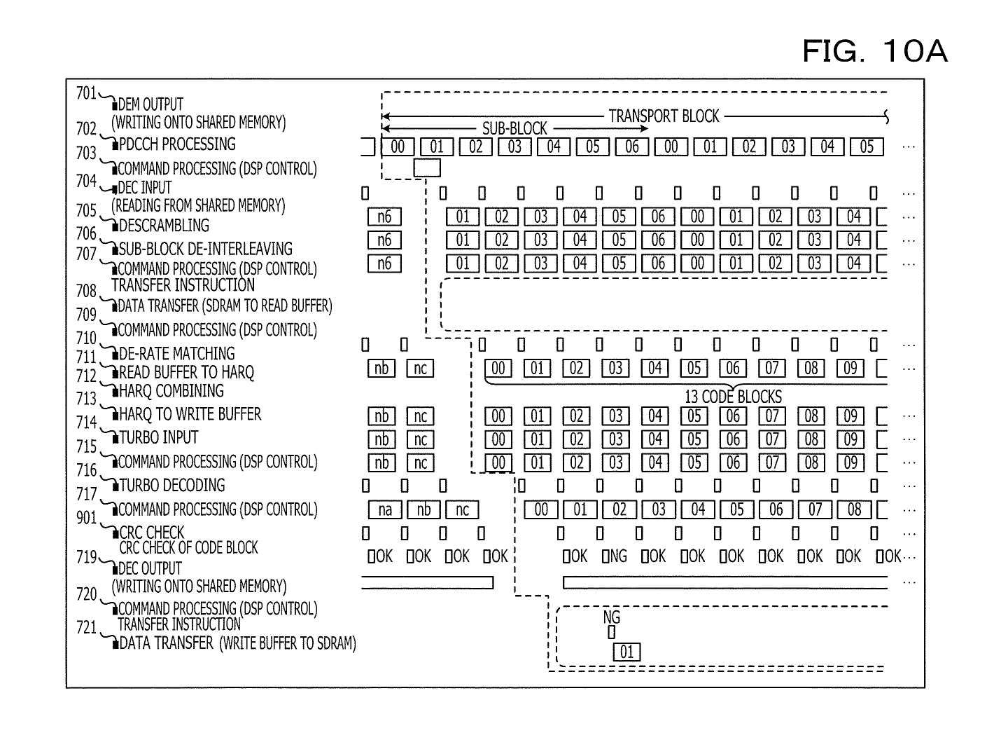

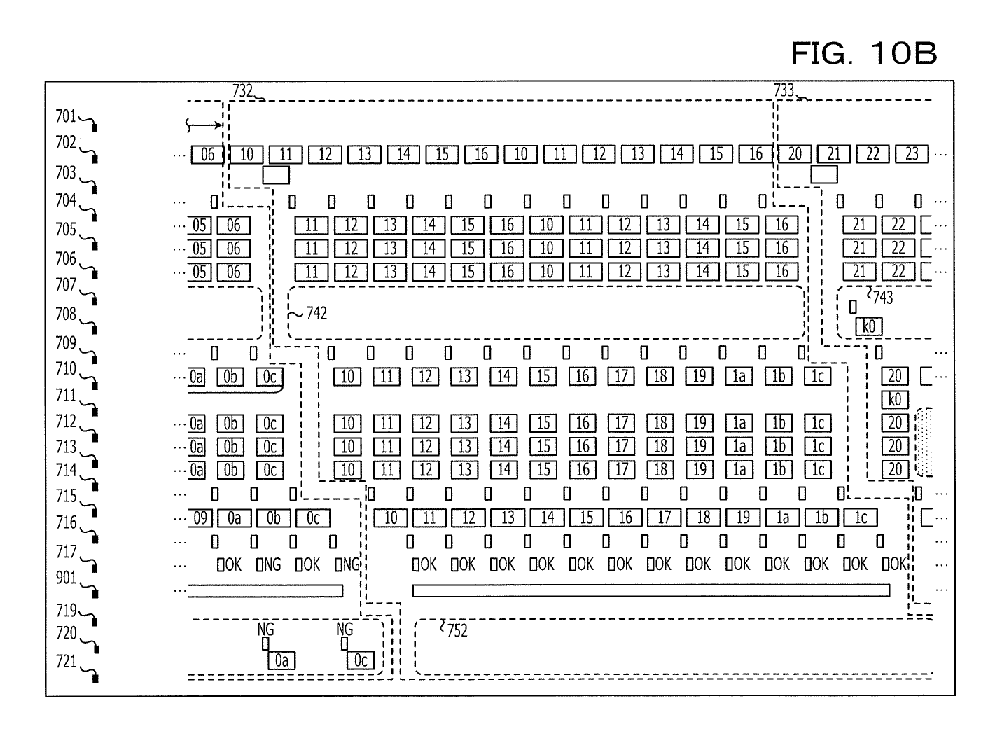

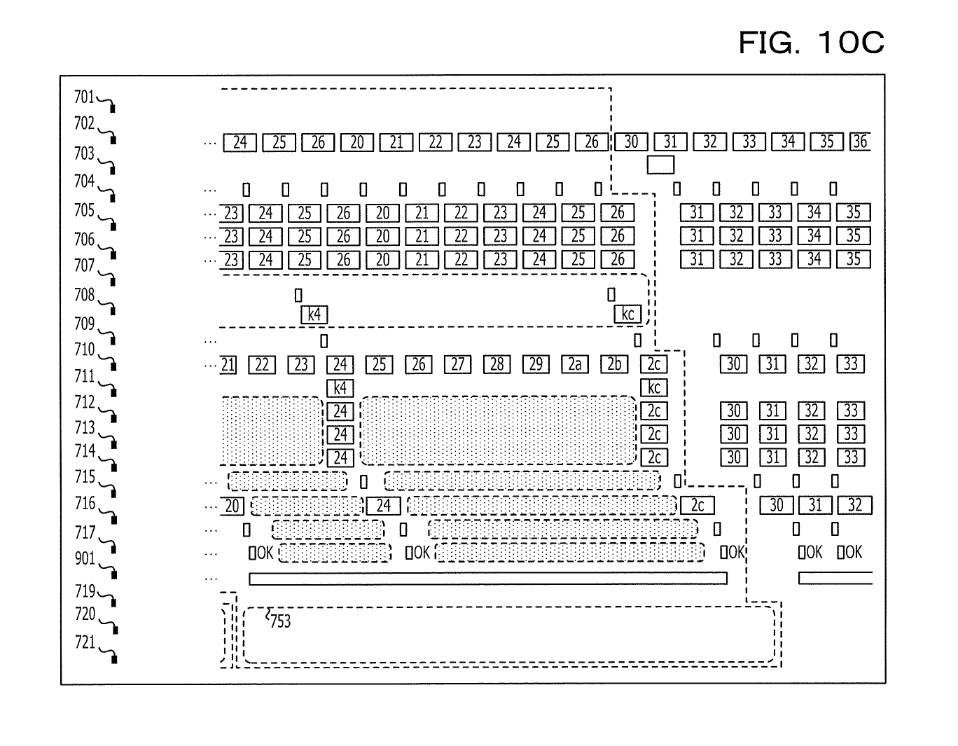

FIGS. 10A to 10C are diagram illustrating a fourth example of processing timing of each of the units in the decoder. In FIGS. 10A to 10C, the same symbol is assigned to a portion that is similar to the portion illustrated in FIGS. 7A to 7C, and the description thereof is omitted.

In the examples illustrated in FIGS. 10A to 10C, the code block in which CRC check in the unit of the code block is determined to be NG is transferred to the memory 221 (SDRAM), and the other pieces of data are not transferred to the memory 221. In this case, before waiting for a result of CRC check in the unit of the transport block, at the time at which CRC check in the unit of the code block is determined to be NG, the code block may be transferred to the memory 221 (SDRAM). As a result, for example, as compared with the examples of FIGS. 9A to 9C, a reduction in the capacity of the write buffer 419 may be achieved.

The write buffer 419 in the examples illustrated in FIGS. 10A to 10C may have, for example, a buffer capacity of three code blocks. However, when the transfer capacity from the write buffer 419 to the memory 221 (SDRAM) or the processing capacity of the circuit is high, the write buffer 419 may have a buffer capacity of one code block or two code blocks. In addition, when the transfer capacity of the bus or the processing capacity of the circuit is low, the write buffer 419 may have a buffer capacity of four code blocks or more.

As described above, only data in the unit of the code block in which an error is detected, from among the pieces of data that are stored in the write buffer 419, may be transferred to the memory 221 using the error detection result in the unit of the code block (second block). As a result, an access to the memory 221 is reduced to suppress the power consumption. In addition, an amount of data that is stored in the memory 221 is reduced, thereby supporting further increase in the data rate.

In FIGS. 7A to 10C, the example of LTE is described, but in HSDPA, CRC check is not defined in the unit of the code block, so that in the case of HSDPA, for example, the examples of FIG. 7A to FIG. 8C may be applied. However, even in HSDPA, when an error is determined in the units of the code blocks, the examples of FIG. 9A to FIG. 10C may be also applied.

(Capacity of the IR Buffer)

In LTE and HSDPA, a software/channel bit number is increased in proportion to the data rate. In addition, a capacity that is desired for an IR buffer in HARQ is determined by the software/channel bit number and a log-likelihood ratio (LLR), and becomes the capacity of eight processes in a case of frequency division duplex (FDD) of LTE.

For example, the size of an IR buffer in Category 7 that is defined in TS36.306 of 3GPP corresponds to “3,654,144×7=25,579,008 [bit]” when the LLR is set as 7. Therefore, it is difficult to provide an IR buffer in a free space of the shared memory 314 (for example, an SRAM) that is included in the baseband processor 220.

On the other hand, in the signal processing device 110, an IR buffer may be provided in an external memory while the power consumption is suppressed, so that an increase in the capacity of the IR buffer is facilitated, thereby supporting a high data rate.

As described above, in the signal processing device, the control method, and the communication device, an increase in the capacity of an IR buffer is facilitated, and the power consumption may be suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A signal processing device comprising:
a first memory; and
a processing circuit coupled to the first memory and configured to
perform decoding of a first received signal based on first likelihood data of the first received signal,
transfer the first likelihood data to a second memory that is external to the signal processing device, only when the decoding is unsuccessful, and
combine the first likelihood data loaded from the second memory with second likelihood data of a second received signal that corresponds to retransmitted signal of the first received signal.

2. The signal processing device according to claim 1, wherein
the processing circuit is configured to store the first likelihood data to the first memory before transferring to the second memory.

3. The signal processing device according to claim 1, wherein
the processing circuit is configured to store the first likelihood data loaded from the second memory to the first memory before combining with the second likelihood data.

4. The signal processing device according to claim 2, wherein
the first received signal is received by a first block and
the first likelihood data is transferred from the first memory to the second memory by a second block that are smaller than the first block.

5. The signal processing device according to claim 4, wherein
the processing circuit is configured to
perform the decoding based on the first likelihood data by the second block, and
transfer only the second block of the first likelihood data whose decoding is unsuccessful, to the second memory.

6. The signal processing device according to claim 1, wherein
the first memory is a static random access memory, and
the second memory is a dynamic random access memory.

7. A signal processing method performed by a signal processing device including a first memory, the signal processing method comprising:
performing decoding of a first received signal based on first likelihood data of the first received signal;
transferring the first likelihood data to a second memory that is external to the signal processing device, only when the decoding is unsuccessful; and
combining, by a processor in the signal processing device, the first likelihood data loaded from the second memory with second likelihood data of a second received signal that corresponds to retransmitted signal of the first received signal.

8. A communication device comprising:
a second memory; and
a processor including a first memory and configured to
perform decoding of a first received signal based on first likelihood data of the first received signal,
transfer the first likelihood data to a second memory that is external to the signal processing device, only when the decoding is unsuccessful, and
combine the first likelihood data loaded from the second memory with second likelihood data of a second received signal that corresponds to retransmitted signal of the first received signal.
